(19) United States
(12) Patent Application Publication
(10) Pub. No.: US 2025/0033288 A1
(43) Pub. Date: Jan. 30, 2025

(54) METHOD OF MANUFACTURING THREE-DIMENSIONAL SHAPED ARTICLE

(71) Applicant: SEIKO EPSON CORPORATION, Tokyo (JP)

(72) Inventor: Keigo ISHIKURA, SHIOJIRI-SHI (JP)

(21) Appl. No.: 18/783,562

(22) Filed: Jul. 25, 2024

(30) Foreign Application Priority Data
Jul. 26, 2023 (JP) 2023-121695

(51) Int. Cl. B29C 64/386; B29C 64/106; B33Y 10/00; B33Y 50/00

(52) U.S. Cl. CPC B29C 64/386; B29C 64/106; B33Y 10/00; B33Y 50/00

(57) ABSTRACT

A method of manufacturing a three-dimensional shaped article by ejecting a plasticized material from an ejection unit toward a stage to stack layers includes: (a) acquiring first data representing a shape of the three-dimensional shaped article; (b) acquiring time designation information designating a molding time in which molding of the three-dimensional shaped article is completed; (c) generating second data including information of a path of the ejection unit to the stage and information of an ejection amount of the plasticized material in the path so that molding of the three-dimensional shaped article is completed within the molding time designated based on the first data and the time designation information; and (d) controlling the ejection unit based on the second data to mold the three-dimensional shaped article.

The present application is based on, and claims priority from JP Application Serial Number 2023-121695, filed Jul. 26, 2023, the disclosure of which is hereby incorporated by reference herein in its entirety.

### BACKGROUND

### 1. Technical Field

The present disclosure relates to a method of manufacturing a three-dimensional shaped article.

### 2. Related Art

JP-A-2022-166868 discloses a method of manufacturing a three-dimensional shaped article, in which selection of a shaping mode including at least one of a mode relating to strength of the three-dimensional shaped article and a mode relating to molding time of the three-dimensional shaped article is accepted, and molding data for shaping the three-dimensional shaped article is generated based on the shaping mode thus accepted.

JP-A-2022-166868 is an example of the related art.

In the manufacturing method described in JP-A-2022-166868, it is possible to change the molding time of the three-dimensional shaped article in accordance with the shaping mode, but it is not considered to designate the molding time of the three-dimensional shaped article.

### SUMMARY

According to a first aspect of the present disclosure, there is provided a method of manufacturing a three-dimensional shaped article by ejecting a plasticized material from an ejection unit toward a stage to stack layers. The method for manufacturing a three-dimensional shaped article includes: (a) acquiring first data representing a shape of the three-dimensional shaped article; (b) acquiring time designation information designating a molding time in which molding of the three-dimensional shaped article is completed; (c) generating, based on the first data and the time designation information, second data including information of a path of the ejection unit to the stage, and information of an ejection amount of the plasticized material in the path so that molding of the three-dimensional shaped article is completed within the molding time designated; and (d) controlling the ejection unit based on the second data to mold the three-dimensional shaped article.

### BRIEF DESCRIPTION OF THE DRAWINGS

FIG. 1 is an illustration diagram illustrating a schematic configuration of a three-dimensional molding system.

FIG. 2 is a perspective view showing a schematic configuration of a screw.

FIG. 3 is a schematic plan view of a screw facing portion.

FIG. 4 is an illustration diagram schematically showing how a three-dimensional shaped article is formed.

FIG. 5 is a view of the three-dimensional shaped article from above.

FIG. 6 is an illustration diagram illustrating a schematic configuration of an information processing device.

FIG. 7 is a diagram showing an example of setting items used to generate molding data.

FIG. 8 is a process diagram of a method of manufacturing a three-dimensional shaped article.

FIG. 9 is a detailed flowchart of molding data generation processing.

FIG. 10 is a diagram showing an example of shaping schedule information.

FIG. 11 is a flowchart of molding data regeneration processing in a third embodiment.

FIG. 12 is a diagram showing a state in which shaping schedule information is updated.

FIG. 13 is a flowchart of molding data regeneration processing in a fourth embodiment.

FIG. 14 is an illustration diagram of molding data regeneration processing according to the fourth embodiment.

FIG. 15 is a diagram showing an example of shaping schedule information according to a fifth embodiment.

FIG. 16 is a process diagram of a method of manufacturing a three-dimensional shaped article according to a sixth embodiment.

### DESCRIPTION OF EMBODIMENTS

### A. First Embodiment

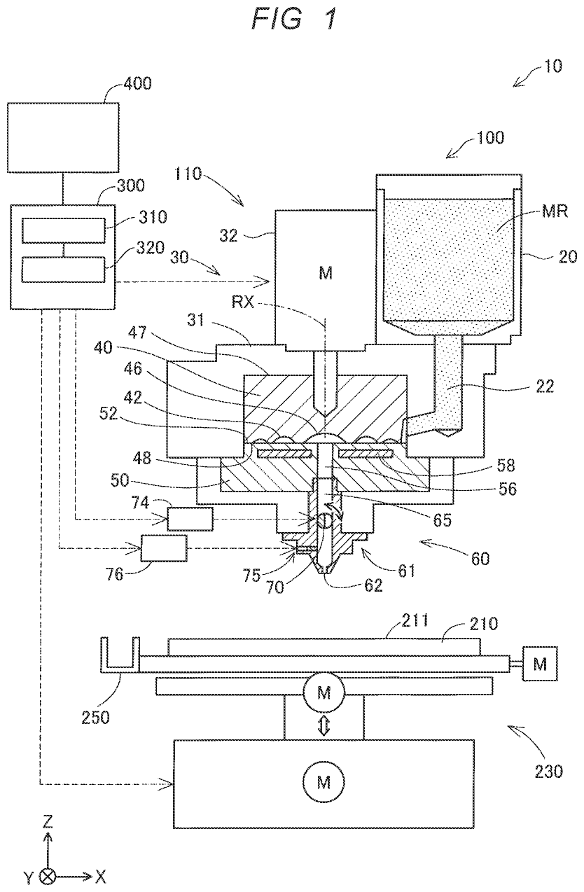

FIG. 1 is an illustration diagram illustrating a schematic configuration of a three-dimensional molding system 10 according to a first embodiment. In FIG. 1, arrows indicating X, Y, and Z directions orthogonal to one another are shown. The X direction and the Y direction are directions parallel to a horizontal plane, and the Z direction is a direction along a vertically upward direction. Arrows indicating the X, Y, and Z directions are appropriately shown in other drawings in a manner in which shown directions correspond to those in FIG. 1. In the following description, when a direction is specified, a direction indicated by an arrow in each drawing is defined as “+” and an opposite direction is defined as “−”, and positive and negative signs are used in combination in a direction notation. Hereinafter, a +Z direction is also referred to as “upper”, and a −Z direction is also referred to as “lower”.

The three-dimensional molding system 10 includes a three-dimensional molding apparatus 100 and an information processing device 400. The three-dimensional molding apparatus 100 of the present embodiment is an apparatus that shapes a three-dimensional shaped article by a material extrusion method. The three-dimensional molding apparatus 100 includes a controller 300 for controlling units of the three-dimensional molding apparatus 100. The controller 300 and the information processing device 400 are communicably coupled to each other.

The three-dimensional molding apparatus 100 includes a molding unit 110 that generates and ejects a plasticized material, a stage 210 for molding that serves as a base of the three-dimensional shaped article, and a moving mechanism 230 that controls an ejection position of the plasticized material.

Under the control of the controller 300, the molding unit 110 ejects the plasticized material in a paste form obtained by melting the material in a solid state onto the stage 210. The molding unit 110 includes a material supply unit 20 that is a supply source of the material to be converted into the plasticized material, a plasticizing unit 30 that converts the material into the plasticized material, and an ejection unit 60 that ejects the plasticized material.

The material supply unit 20 supplies a raw material MR for manufacturing a plasticized material to the plasticizing unit 30. The material supply unit 20 is formed of, for example, a hopper that accommodates the raw material MR. The material supply unit 20 has a discharge port at a lower side. The discharge port is coupled to the plasticizing unit 30 via a communication path 22. The raw material MR is put into the material supply unit 20 in a form of pellets, powder, or the like. As the raw material MR, a resin material such as acrylonitrile butadiene styrene (ABS), polyether ether ketone (PEEK), or polypropylene (PP) is used.

The plasticizing unit 30 melts the raw material MR supplied from the material supply unit 20 to generate a paste-like plasticized material exhibiting fluidity, and guides the plasticized material to the ejection unit 60. The plasticizing unit 30 includes a screw case 31, a drive motor 32, a screw 40, and a screw facing part 50. The screw 40 in the present embodiment is also called a flat screw, a rotor, or a scroll, and the screw facing part 50 is also called a barrel.

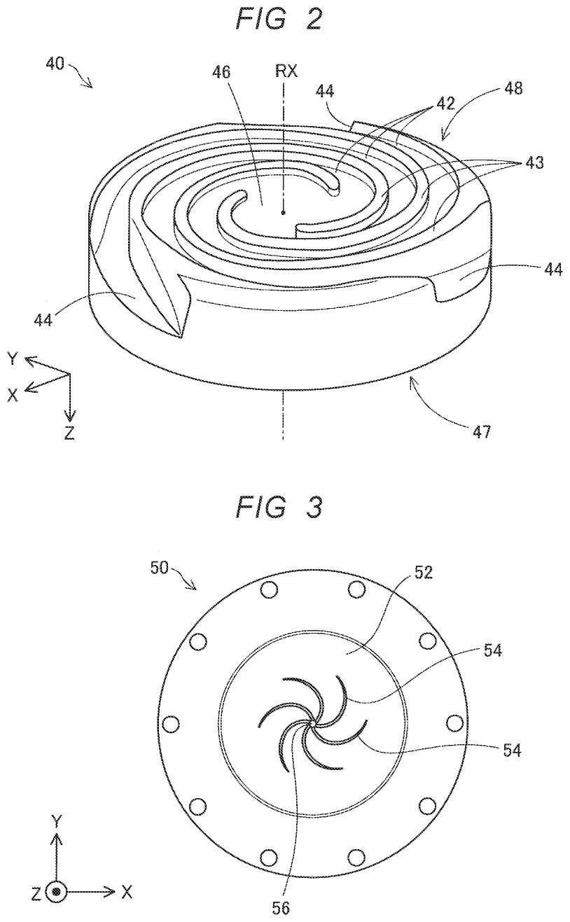

FIG. 2 is a perspective view showing a schematic configuration at a lower surface 48 side of the screw 40. FIG. 3 is a schematic plan view showing upper surface 52 side of the screw facing part 50. In order to facilitate understanding of the technique, the screw 40 shown in FIG. 2 is shown in a state in which the positional relationship between an upper surface 47 and the lower surface 48 shown in FIG. 1 is reversed in a vertical direction. The screw 40 has a substantially cylindrical shape in which a length in an axial direction which is a direction along a central axis thereof is smaller than a length in a direction perpendicular to the axial direction. The screw 40 is disposed such that a rotation axis RX forming a rotation center thereof is parallel to the Z direction.

The screw 40 is housed in the screw case 31. The upper surface 47 side of the screw 40 is coupled to the drive motor 32, and the screw 40 rotates in the screw case 31 by rotational drive force generated by the drive motor 32. The drive motor 32 is driven under the control of the controller 300. Note that the screw 40 may be driven by the drive motor 32 via a decelerator.

Groove parts 42 each having a vortical shape are formed on the lower surface 48 of the screw 40, the lower surface being a surface crossing the rotation axis RX. The communication path 22 of the material supply unit 20 communicates with the groove parts 42 from the side surface of the screw 40. In the present embodiment, the three groove parts 42 are formed so as to be separated by protruding line parts 43 as shown in FIG. 2. The number of groove parts 42 is not limited to three, and may be one, or two or more. The groove parts 42 are each not limited to a vortical shape, and may have a spiral shape or an involute curve shape, or may have a shape extending in an arc from a central portion toward an outer circumference.

The lower surface 48 of the screw 40 faces an upper surface 52 of the screw facing part 50, and spaces are formed between the groove parts 42 on the lower surface 48 of the screw 40 and the upper surface 52 of the screw facing part 50. In the molding unit 110, the raw material MR is supplied from the material supply unit 20 to material inlets 44 shown in FIG. 2 of these spaces between the screw 40 and the screw facing part 50.

A heater 58 for heating the raw material MR supplied into the groove parts 42 of the screw 40 that is rotating is embedded in the screw facing part 50. As shown in FIG. 3, the screw facing part 50 is provided with a plurality of guide grooves 54 that is coupled to a communication hole 56 and extends to form vortical shapes from the communication hole 56 toward the outer periphery. One end of the guide groove 54 may not be coupled to the communication hole 56. The guide grooves 54 may be omitted.

The raw material MR supplied into the groove parts 42 of the screw 40 flows along the groove parts 42 due to the rotation of the screw 40 while being melted in the groove parts 42, and is guided to a central portion 46 of the screw 40 as a plasticized material. The plasticized material that is in a paste state, that exhibits fluidity, and that flows into the central portion 46 is supplied to the ejection unit 60 through the communication hole 56 provided at the center of the screw facing part 50. In the plasticized material, not all kinds of substances constituting the plasticized material are required to be melted. It is sufficient for the plasticized material to be converted into the state having fluidity as a whole by melting at least some kinds of the substances constituting the plasticized material.

The ejection unit 60 includes a nozzle 61 that ejects the plasticized material, a flow path 65 of the plasticized material provided between the screw 40 and a nozzle opening 62, an ejection adjustment unit 70 that opens and closes the flow path 65, and a suction unit 75 that suctions and temporarily stores the plasticized material. The nozzle 61 is coupled to the communication hole 56 of the screw facing part 50 through the flow path 65. Through the nozzle 61, the plasticized material generated in the plasticizing unit 30 is extruded from the nozzle opening 62 at a tip end of the nozzle 61 toward the stage 210. A heater that prevents a decrease in temperature of the plasticized material ejected onto the stage 210 may be disposed around the nozzle 61.

The ejection adjustment unit 70 is provided in the flow path 65 communicating with the nozzle opening 62 to change an aperture of the flow path 65 by rotating in the flow path 65. In the present embodiment, the ejection adjustment unit 70 is formed of a valve. The ejection adjustment unit 70 is driven by a first drive unit 74 under the control of the controller 300. The first drive unit 74 is implemented with, for example, a stepping motor. The controller 300 is capable of adjusting the flow rate of the plasticized material flowing from the plasticizing unit 30 to the nozzle 61 by controlling the rotation angle of the valve using the first drive unit 74. The ejection adjustment unit 70 adjusts the flow rate of the plasticized material and controls ON/OFF of outflow of the plasticized material.

The suction unit 75 is coupled between the extruding adjustment unit 70 and the nozzle opening 62 in the flow path 65. The suction unit 75 temporarily suctions the plasticized material in the flow path 65 when extruding of the plasticized material from the nozzle 61 is stopped, thereby preventing a tailing phenomenon in which the plasticized material drips down from the nozzle opening 62 like a string. In the embodiment, the suction unit 75 is implemented by a plunger. The suction unit 75 is driven by a second drive unit 76 under the control of the controller 300. The second drive unit 76 is implemented with, for example, a stepping motor, or a rack-and-pinion mechanism that converts a rotational force of the stepping motor into a translational motion of the plunger.

The stage 210 is disposed at a position facing the nozzle opening 62 of the nozzle 61. In the first embodiment, a molding surface 211 of the stage 210 facing the nozzle opening 62 of the nozzle 61 is parallel to the X and Y directions, that is, a horizontal direction. The three-dimensional molding apparatus 100 shapes a three-dimensional shaped article by ejecting the plasticized material from the ejection unit 60 toward the molding surface 211 of the stage 210 to stack layers. The stage 210 may be provided with a heater for preventing rapid cooling of the plasticized material ejected onto the stage 210.

The moving mechanism 230 changes a relative position between the stage 210 and the nozzle 61. In the embodiment, a position of the nozzle 61 is fixed, and the moving mechanism 230 moves the stage 210. The moving mechanism 230 is implemented with a three-axis positioner that moves the stage 210 in three-axial directions of X, Y, and Z directions by driving forces of three motors. The moving mechanism 230 changes the relative positional relationship between the nozzle 61 and the stage 210 under the control of the controller 300. In the present specification, unless otherwise specified, a movement of the nozzle 61 refers to moving the nozzle 61 or the ejection unit 60 relatively to the stage 210.

In another embodiment, a configuration in which the moving mechanism 230 moves the nozzle 61 relative to the stage 210 in a state in which a position of the stage 210 is fixed may be adopted instead of a configuration in which the stage 210 is moved by the moving mechanism 230. Further, a configuration in which the stage 210 is moved in the Z direction by the moving mechanism 230 and the nozzle 61 is moved in the X and Y directions or a configuration in which the stage 210 is moved in the X and Y directions by the moving mechanism 230 and the nozzle 61 is moved in the Z direction may be adopted. With such configurations, a relative positional relationship between the nozzle 61 and the stage 210 can also be changed.

A waste material container 250 is disposed in a region outside the molding surface 211 of the stage 210. In the waste material container 250, the plasticized material discarded from the nozzle 61 during maintenance of the nozzle 61 is discharged. A brush for cleaning the nozzle 61 may be disposed above the waste material container 250 toward the nozzle 61.

The controller 300 is a control device that controls an overall operation of the three-dimensional molding apparatus 100. The controller 300 is formed of a computer including one processor 310 or a plurality of processors 310, a storage device 320, and an input-and-output interface that inputs and outputs signals to and from the outside. By executing a program stored in the storage device 320, the processor 310 controls the three-dimensional molding apparatus 100 according to the molding data acquired from the information processing device 400 to print the three-dimensional shaped article on the stage 210. The controller 300 may be implemented by a combination of circuits instead of being formed of a computer.

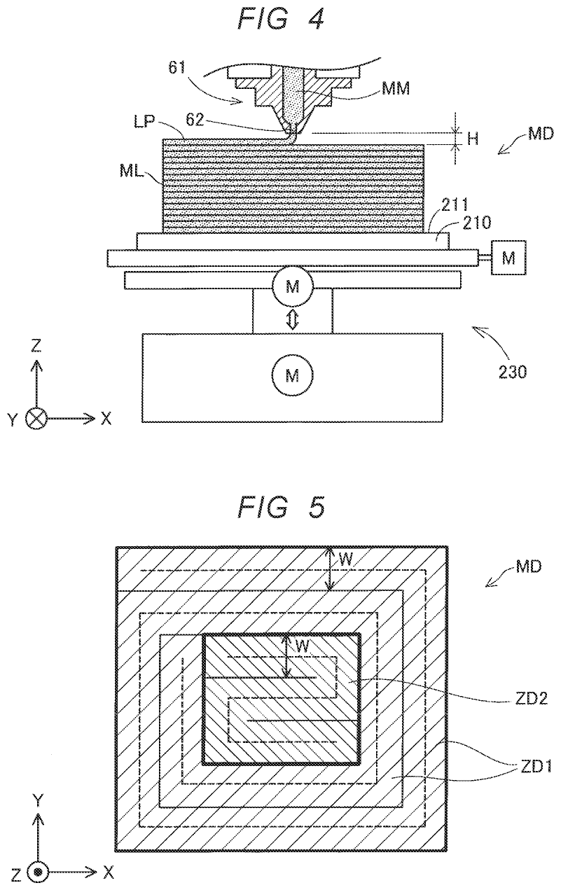

FIG. 4 is an illustration diagram schematically illustrating how the three-dimensional shaped article MD is shaped in the three-dimensional molding apparatus 100. FIG. 5 is a top view of the three-dimensional shaped article MD during the shaping. In the three-dimensional molding apparatus 100, as described above, in the plasticizing unit 30, the raw material MR in the solid state supplied to the groove parts 42 of the screw 40 that is rotating is melted to generate a plasticized material MM. As shown in FIG. 4, the controller 300 causes the nozzle 61 to eject the plasticized material MM while scanning the molding surface 211 with the nozzle 61 in the direction along the molding surface 211 while keeping the distance from the nozzle 61 to the molding surface 211 or an anterior layer already molded at an ejection height H designated in advance. As shown in FIG. 5, in the present embodiment, the controller 300 shapes an outline region ZD1 including the outermost periphery of the three-dimensional shaped article MD, and then forms an internal region ZD2 located inside the outline region ZD1. The controller 300 shapes the outline region ZD1 in accordance with the number of passes designated in advance. FIG. 5 shows a state in which the outline region ZD1 is shaped by two passes. FIG. 5 shows a state in which the internal region ZD2 is shaped inside the outline region ZD1 by a meandering path. The controller 300 forms the internal region ZD2 according to an internal filling rate designated in advance. FIG. 5 shows a state in which the internal region ZD2 having an internal filling rate of 100% is shaped. When the internal filling rate is less than 100%, the internal region ZD2 is formed such that a gap is formed between the plasticized materials deposited to form linear shapes. The plasticized material MM having a thickness according to a line width W designated in advance is ejected from the nozzle 61 to shape the outline region ZD1 and the internal region ZD2. As shown in FIGS. 4 and 5, the plasticized material ejected from the nozzle 61 is continuously deposited in the moving direction of the nozzle 61.

As shown in FIG. 4, the controller 300 repeats the scanning with the nozzle 61 to form a layer ML. After forming one layer ML, the controller 300 moves the position of the nozzle 61 with respect to the stage 210 in the +Z direction. Then, another layer ML is further stacked on the layer ML formed so far to thereby continuously shape the three-dimensional shaped article MD.

When the shaping of the layer ML corresponding to one layer is completed or when a plurality of forming regions independent of each other in each layer is formed, the controller 300 may temporarily interrupt the ejection of the plasticized material from the nozzle 61. For example, when the shaping is performed on different places in the same layer, the controller causes the ejection adjustment unit 70 to close the flow path 65 to stop the ejection of the plasticized material MM from the nozzle opening 62, and causes the suction unit 75 to temporarily suction the plasticized material located in the nozzle 61. The controller 300 moves the nozzle 61 in the +Z direction according to a retraction amount designated in advance and changes the position of the nozzle 61 in the X and Y directions. Then, the position of the nozzle 61 in the Z direction is restored, and the flow path 65 is opened by the ejection adjustment unit 70 while ejecting the plasticized material located in the suction unit 75, whereby the deposition of the plasticized material MM is restarted from the position of the nozzle 61 after the movement.

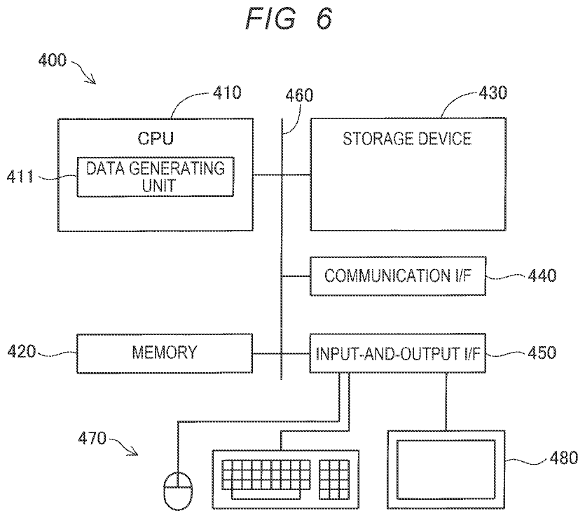

FIG. 6 is an illustration diagram showing a schematic configuration of the information processing device 400. The information processing device 400 is implemented as a computer in which a CPU 410, a memory 420, a storage device 430, a communication interface 440, and an input-and-output interface 450 are coupled to each other with a bus 460. An input device 470 such as a keyboard and a mouse and a display unit 480 such as a liquid crystal display are coupled to the input-and-output interface 450. The information processing device 400 is coupled to the controller 300 of the three-dimensional molding apparatus 100 via the communication interface 440.

The CPU 410 functions as a data generation unit 411 by executing a program stored in the storage device 430.

The data generation unit 411 generates molding data. The molding data means data representing information related to the movement path of the nozzle 61 with respect to the stage 210, an amount of the plasticized material ejected from the nozzle 61, rotation speed of the screw 40, and so on. The data generation unit 411 reads shape data representing the shape of the three-dimensional shaped article formed using three-dimensional CAD software or three-dimensional CG software, and divides the shape of the three-dimensional shaped article into layers having a predetermined thickness. As the shape data, data in an STL format or an AMF format is used. The data generation unit 411 generates the molding data by determining the movement path of the nozzle 61 and the amount of the plasticized material so as to fill each of the layers thus divided with the plasticized material. The molding data is represented by a G code, an M code, or the like. The shape data corresponds to first data in the present application. The molding data corresponds to second data in the present application. A format of the first data is not limited to the format of the shape data described above, and may be substantially the same as a format of the second data. The data of each layer obtained by dividing the shape data may be the first data.

The molding data includes path information representing the movement path of the ejection unit 60, ejection amount information representing the ejection amount of the plasticized material on each movement path, information representing the moving speed of the nozzle 61, and information related to maintenance. The movement path of the ejection unit 60 means a path on which the nozzle 61 moves along the molding surface 211 of the stage 210 while ejecting the plasticized material.

The path information includes a plurality of partial paths. Each of the partial paths is a linear path represented by a start point and an end point. The ejection amount information is individually associated with each of the partial paths. In the present embodiment, the ejection amount represented by the ejection amount information is the amount of the plasticized material ejected per unit time in the partial path. In another embodiment, the total amount of the plasticized material ejected in the entire partial path may be associated with each of the partial paths as the ejection amount information.

The data generation unit 411 generates molding data in accordance with a setting value of a predetermined setting item.

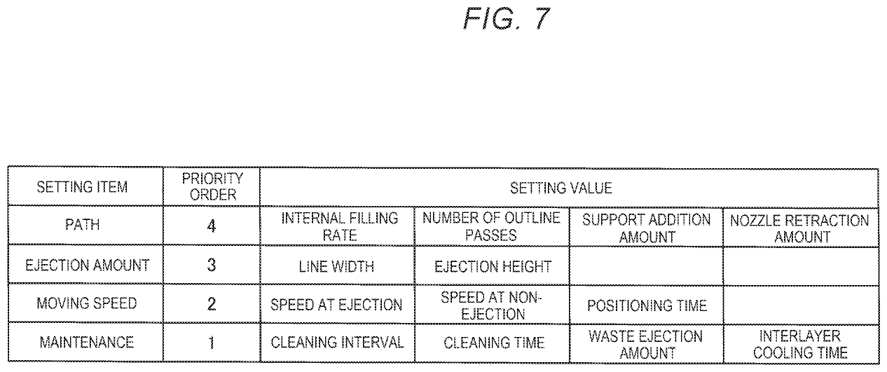

FIG. 7 is a diagram illustrating an example of setting items used to generate the molding data. The setting items include a setting related to the paths, a setting related to the ejection amount, a setting related to the moving speed of the ejection unit 60, and a setting related to the maintenance of the ejection unit 60.

The setting related to the paths includes at least one of the internal filling rate, the number of outline passes, the support addition amount, and the nozzle retraction amount as a setting value which can be set. The internal filling rate is the filling rate of the internal region ZD2 shown in FIG. 5. The number of outline passes is the number of passes for forming the outline region ZD1 shown in FIG. 5. The support addition amount is an amount of a support structure for supporting an overhang portion provided to the three-dimensional shaped article. The support addition amount is represented by, for example, a ratio of actually forming the support structure with respect to a region in which the support structure can be formed. The nozzle retraction amount is an amount by which the nozzle 61 is moved in the +Z direction when the nozzle 61 is moved to another place in the same layer.

The setting related to the ejection amount includes at least one of the line width and the ejection height as a setting value which can be set. The line width is the line width W shown in FIG. 5. The ejection height is the ejection height H shown in FIG. 4.

The setting related to the moving speed includes at least one of speed at ejection, speed at non-ejection, and positioning time as a setting value which can be set. The speed at ejection is speed at which the nozzle 61 is moved while ejecting the plasticized material from the nozzle 61. The speed at non-ejection is speed at which the nozzle 61 is moved while the ejection of the plasticized material from the nozzle 61 is stopped. The positioning time is time for temporarily stopping the nozzle 61 at the start point or the end point of the ejection in order to fix the plasticized material to the molding surface 211 or the anterior layer.

The setting related to the maintenance includes at least one of a cleaning interval, a cleaning time, a waste ejection amount, and an interlayer cooling time as a setting value which can be set. The cleaning interval means a time interval for cleaning the nozzle 61. The cleaning time means cleaning time for each cleaning of the nozzle 61. The waste ejection amount means an amount of the plasticized material to be ejected into the waste material container 250 in each cleaning of the nozzle 61. The interlayer cooling time is a cooling time for fixing the shape of one layer after the layer is shaped.

Priority order is predetermined in advance for each of the setting items. The priority order is an order representing how easily the setting value is changed in the data generation processing described later. In the present embodiment, as illustrated in FIG. 7, the priority order of the setting related to the maintenance is the highest, the priority order of the setting related to the moving speed is the second highest, the priority order of the setting related to the ejection amount is the third highest, and the priority order of the setting related to the paths is the lowest. That is, the setting related to the maintenance is the most likely to be changed, and the setting related to the paths is the most unlikely to be changed. The priority order is assigned according to the degree of influence on the molding quality. That is, the degree of influence of the setting related to the paths on the molding quality is the highest, and the degree of influence of the setting related to the maintenance on the molding quality is the lowest. The priority order may be changeable by the user.

Each setting value affects the molding accuracy of the three-dimensional shaped article. Therefore, by changing each setting value from the initial value, the molding accuracy of the three-dimensional shaped article becomes higher or lower. The higher the molding accuracy of the three-dimensional shaped article, the longer the molding time, and the lower the molding accuracy of the three-dimensional shaped article, the shorter the molding time. For example, as the setting value of the ejection height increases, the molding accuracy decreases, and as the setting value of the ejection height decreases, the molding accuracy increases. The closer the internal filling rate is to 0%, the lower the molding accuracy becomes, and the closer the internal filling rate is to 100%, the higher the molding accuracy becomes. A minimum value and a maximum value are determined for each setting value. For example, the minimum value and the maximum value of the line width and the ejection height are determined by the diameter of the nozzle opening 62. Therefore, the setting value is changed in a range between such minimum value and maximum value.

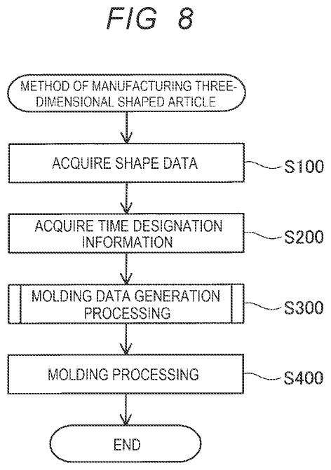

FIG. 8 is a process diagram of a method of manufacturing a three-dimensional shaped article. In step S100, the data generation unit 411 of the information processing device 400 acquires the shape data representing the shape of the three-dimensional shaped article. The data generation unit 411 acquires the shape data from, for example, the storage device 430 in the information processing device 400 or another device connected via the communication interface 440.

In step S200, the data generation unit 411 acquires time designation information for designating the molding time of the three-dimensional shaped article. The molding time of the three-dimensional shaped article is a time period for completing the molding of the three-dimensional shaped article, and is a time from the start of the molding of the three-dimensional shaped article to the completion of the molding. The molding time is, for example, one hour or two hours. The data generation unit 411 acquires time designation information from the user through the input device 470. Hereinafter, the molding time represented by the time designation information is also referred to as “required time”.

In step S300, the data generation unit 411 executes a molding data generation processing. Through the molding data generation processing, the molding data is generated based on the shape data acquired in step S100 and the time designation information acquired in step S200 so that the molding of the three-dimensional shaped article is completed within the molding time thus designated. Details of the molding data generation processing will be described later.

In step S400, the controller 300 of the three-dimensional molding apparatus 100 executes molding processing. In the molding processing, the controller 300 acquires molding data from the information processing device 400, and shapes a three-dimensional shaped article on the molding surface 211 of the stage 210 by controlling the ejection adjustment unit 70 and the moving mechanism 230 while analyzing the acquired molding data.

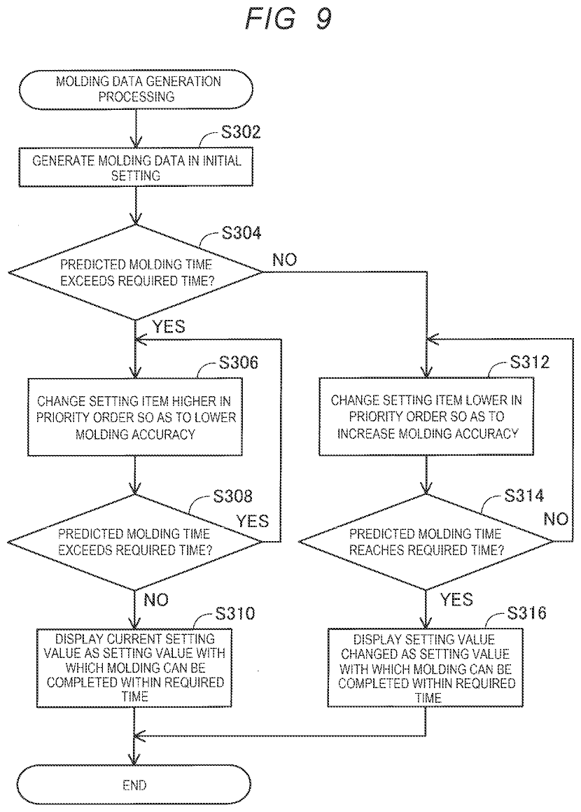

FIG. 9 is a detailed flowchart of the molding data generation processing in the first embodiment. In step S302, the data generation unit 411 generates molding data while maintaining the setting values of the setting items illustrated in FIG. 7 as initial values. At this time, the data generation unit 411 generates the molding data and calculates the molding time during which the three-dimensional shaped article is molded based on the molding data. The data generation unit 411 calculates the molding time by, for example, multiplying the path length of the path constituting the outline region ZD1 and the internal region ZD2 of the three-dimensional shaped article by the moving speed of the nozzle 61, and further integrating the time required for the maintenance, the time required for positioning, and the time for molding the support structure. The molding time calculated in step S302 is hereinafter referred to as predicted molding time.

In step S304, the data generation unit 411 determines whether the predicted molding time exceeds the required time designated by the user.

When the data generation unit 411 determines in step S304 that the predicted molding time exceeds the required time, the data generation unit 411 changes the setting value of the setting item high in priority order in step S306 so as to reduce the molding accuracy. Then, the molding data is generated again using the setting value thus changed, and the molding time during which the molding is performed with that molding data is calculated. For example, in the present embodiment, a setting item having the highest priority is the setting item related to the maintenance. Therefore, the data generation unit 411 first changes the setting value of the setting item related to the maintenance so as to reduce the molding accuracy. For example, the lower the cleaning frequency, the shorter the cleaning time, the smaller the waste ejection amount, or the shorter the interlayer cooling time, the lower the molding accuracy and the shorter the molding time. The order of setting values to be changed among the setting items may be determined in advance, or at least two setting values of the setting items may be changed simultaneously.

In step S308, the data generation unit 411 determines again whether the predicted molding time calculated in step S306 exceeds the required time. When it is determined in step S308 that the predicted molding time exceeds the required time, the data generation unit 411 returns the process to step S306 to change the setting value so as to reduce the molding accuracy, and then generate the molding data. For example, a minimum value and a maximum value are defined for each setting value of the setting item related to the maintenance. Therefore, when the data generation unit 411 changes the setting value of the setting item related to the maintenance to the limit, the data generation unit 411 changes the setting value of the setting item related to the moving speed which is the setting item having the next highest priority.

When the data generation unit 411 determines in step S308 that the predicted molding time does not exceed the required time, that is, when the data generation unit 411 determines that the predicted molding time is equal to or less than the required time, the data generation unit 411 displays the current setting value thus changed in step S310 on the display unit 480 as the setting value with which the molding can be achieved within the required time, and then ends the molding data generation processing.

When the data generation unit 411 determines in step S304 that the predicted molding time does not exceed the required time, the data generation unit 411 changes the setting value of the setting item low in priority order in step S312 so as to increase the molding accuracy. Then, the molding data is generated again using the setting value thus changed, and the molding time during which the molding is performed with that molding data is calculated. For example, the setting item the lowest in priority order in the present embodiment is the setting item related to the paths. Therefore, the data generation unit 411 first changes the setting value of the setting item related to the paths so as to increase the molding accuracy. For example, the molding accuracy is increased, and the molding time is increased as the internal filling rate is increased, the number of outline passes is increased, the support addition amount is increased, or the nozzle retraction amount is increased.

In step S314, the data generation unit 411 determines whether the predicted molding time calculated in step S312 has reached the required time. When the data generation unit 411 determines in step S314 that the predicted molding time has not reached the required time, the data generation unit 411 returns the process to step S312 to change the setting value so as to further increase the molding accuracy, and then generates the molding data. For example, when the data generation unit 411 changes the setting value of the setting item related to the paths to the limit, the data generation unit 411 changes the setting value of the setting item related to the ejection amount which is the setting item having the next lowest priority order.

When the data generation unit 411 determines in step S314 that the predicted molding time has reached the required time, the data generation unit 411 displays the current setting value in step S316 on the display unit 480 as the setting value with which the molding can be achieved within the required time, and then ends the molding data generation processing. When the data generation unit 411 determines in step S314 that the predicted molding time exceeds the required time, the data generation unit 411 generates molding data again in step S316 using the setting value used in the previous execution of step S312, displays the setting value on the display unit 480 as the setting value with which the molding can be achieved within the required time, and then ends the molding data generation processing.

According to the method of manufacturing the three-dimensional shaped article of the first embodiment described above, the molding data is generated such that the three-dimensional shaped article is shaped within the molding time designated by the user. Therefore, the convenience for the user can be enhanced.

In the present embodiment, a priority order according to the degree of influence on the molding quality is assigned to setting items of the setting related to the paths, the setting related to the ejection amount, the setting related to the moving speed of the ejection unit 60, and the setting related to the maintenance of the ejection unit 60, and the setting values of the setting items are sequentially changed according to the priority order. Therefore, it is possible to generate the molding data with which the three-dimensional shaped article as high in quality as possible can be molded within the designated molding time.

In the present embodiment, the predicted molding time calculated from the setting value and the molding time designated are compared with each other to determine whether the molding is completed within the molding time designated, and when the molding is not completed within the molding time designated, the molding data is generated by changing the setting value from the setting item high in priority order and repeating the change of the setting value until the predicted molding time calculated from the new molding data generated based on the setting value thus changed falls within the molding time designated. Therefore, it is possible to generate the molding data that enables the three-dimensional shaped article as high in quality as possible to be molded within the molding time designated while making the molding time of the three-dimensional shaped article close to the molding time designated.

### B. Second Embodiment

The configuration of the three-dimensional molding system 10 in a second embodiment is the same as that in the first embodiment. The second embodiment is different from the first embodiment in some of the steps of the method of manufacturing the three-dimensional shaped article.

In the second embodiment, the controller 300 of the three-dimensional molding apparatus 100 manufactures the three-dimensional shaped article according to molding schedule information stored in advance in the storage device 320.

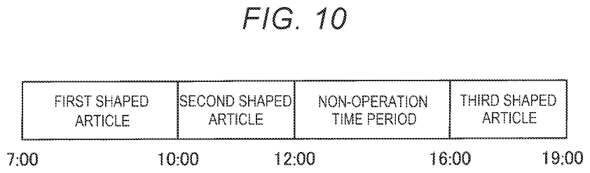

FIG. 10 is a diagram illustrating an example of the molding schedule information. In the molding schedule information, the molding data and information related to date and time when the shaped article is shaped according to the molding data are recorded in association with each other. FIG. 10 illustrates a molding schedule in which a first shaped article is shaped from 7:00 to 10:00, a second shaped article is shaped from 10:00 to 12:00, and a third shaped article is shaped from 16:00 to 19:00. In the storage device 320, the molding data corresponding to the first to third shaped articles acquired from the information processing device 400 is stored. In FIG. 10, a period from 12:00 to 16:00 is indicated as a non-operation time period. The non-operation time period is a time period during which the molding data is not registered, and is a time period during which the three-dimensional molding apparatus 100 is not scheduled to operate.

In the second embodiment, in step S200 of the process diagram illustrated in FIG. 8, the data generation unit 411 of the information processing device 400 acquires the molding schedule information from the three-dimensional molding apparatus 100 to specify the non-operation time period from the molding schedule information thus acquired. The data generation unit 411 acquires the non-operation time period thus specified as time designation information. Thereafter, the data generation unit 411 performs the molding data generation processing in step S300 to generate the molding data such that the molding time falls within the non-operation time period. The molding data thus generated is registered in a time zone which is the non-operation time period in the molding schedule information. In step S400, the controller 300 of the three-dimensional molding apparatus 100 acquires the molding data from the information processing device 400 to perform the molding processing according to the molding schedule information.

According to the second embodiment described above, the molding data for molding the three-dimensional shaped article is generated so that the molding is completed within the non-operation time period in which the operation of the three-dimensional molding apparatus 100 is not scheduled. Therefore, the three-dimensional shaped article can be formed by effectively utilizing the non-operation time period of the three-dimensional molding apparatus. In addition, it is possible to mold the three-dimensional shaped article with the quality corresponding to the length of the non-operation time period. For example, when the non-operation time period is long, high quality molding can be performed, and when the non-operation time period is short, molding as high in quality as possible can be performed within a limited time.

The data generation unit 411 may acquire a part of the non-operation time period as the time designation information instead of acquiring the entire non-operation time period as the time designation information. For example, the data generation unit 411 may acquire time obtained by subtracting the time required for the maintenance of the three-dimensional molding apparatus 100 from the non-operation time period as the time designation information. When there are a plurality of non-operation time periods in the molding schedule information, the data generation unit 411 may acquire the longest one of the non-operation time periods as the time designation information.

### C. Third Embodiment

The configuration of the three-dimensional molding system 10 in a third embodiment is the same as that in the first embodiment. In the third embodiment, the molding data registered in the molding schedule information is regenerated in accordance to the non-operation time period.

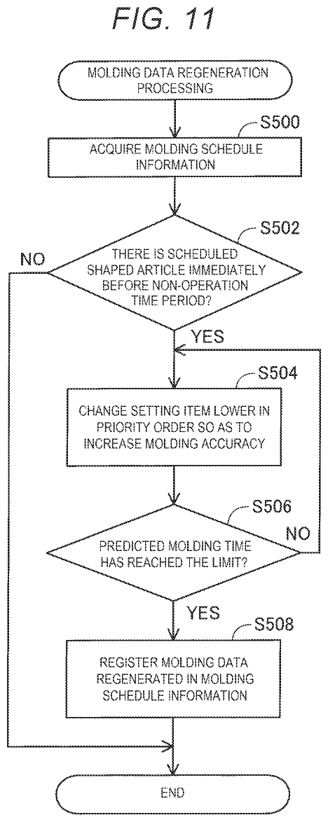

FIG. 11 is a flowchart of molding data regeneration processing executed by the data generation unit 411 of the information processing device 400 in the third embodiment. The molding data regeneration processing is executed when one or more pieces of molding data are registered in the molding schedule information and a predetermined instruction is given from the user.

In step S500, the data generation unit 411 of the information processing device 400 acquires the molding schedule information from the three-dimensional molding apparatus 100.

In step S502, the data generation unit 411 specifies the non-operation time period of the three-dimensional molding apparatus 100 from the molding schedule information thus acquired to determine whether there is the molding data in which the molding is scheduled in a time zone immediately before the non-operation time period. For example, when adopting the molding schedule information illustrated in FIG. 10, since the molding data for molding the second shaped article is registered immediately before the non-operation time period from 12:00 to 16:00, it is determined that there is molding data in which the molding is scheduled in the time zone immediately before the non-operation time period.

When there is no molding data in which the molding is scheduled in the time zone immediately before the non-operation time period or when there is no non-operation time period itself, the data generation unit 411 ends the molding data regeneration processing.

When there is the molding data in which the molding is scheduled in the time zone immediately before the non-operation time period, the data generation unit 411 acquires the molding data from the three-dimensional molding apparatus 100 in step S504, and regenerates the molding data so as to increase the molding accuracy. Specifically, the setting value of the setting item having the low priority order shown in FIG. 9 is changed so that the molding accuracy is increased. Then, the molding data is generated again using the setting value thus changed, and the molding time during which the molding is performed with that molding data is calculated.

In step S506, the data generation unit 411 determines whether the predicted molding time calculated in step S504 has reached a limit. In the present embodiment, “the predicted molding time has reached the limit” means that the predicted molding time has reached the time obtained by adding the non-operation time period to the initial molding time, or that the predicted molding time has not reached the time obtained by adding the non-operation time period to the initial molding time, but the setting value is changed to the limit at which the molding accuracy is increased, and thus the molding time cannot be further increased. When the data generation unit 411 determines in step S506 that the predicted molding time has not reached the limit, the data generation unit 411 returns the process to step S504 to change the setting value so as to increase the molding accuracy, and then generates the molding data. Similarly to the first embodiment, the data generation unit 411 determines the setting item to be changed according to the priority order illustrated in FIG. 7.

When the data generation unit 411 determines in step S506 that the predicted molding time has reached the limit, the data generation unit 411 reregisters the molding data regenerated in step S504 in the molding schedule information in step S508, and then ends the molding data regeneration processing. When the data generation unit 411 determines in step S506 that the predicted molding time exceeds the time obtained by adding the non-operation time period to the initial molding time, the data generation unit 411 generates the molding data again in step S508 using the setting value used in the previous execution of step S504 and reregisters the molding data in the molding schedule information.

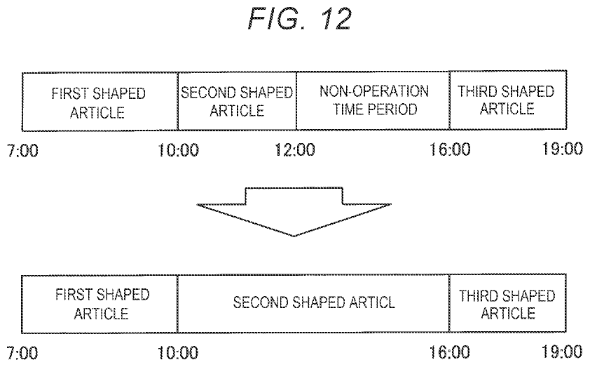

FIG. 12 is a diagram illustrating a state in which the molding schedule information illustrated in FIG. 10 is updated by the molding data regeneration processing according to the third embodiment. As illustrated in FIG. 12, according to the third embodiment, the molding data is regenerated so that the molding time of the molding data scheduled at the time immediately before the non-operation time period is extended within the range of the non-operation time period. Therefore, since the molding time of the three-dimensional shaped article can be extended into the non-operation time period of the three-dimensional molding apparatus 100, the three-dimensional shaped article can be molded with high quality.

In the third embodiment described above, the data generation unit 411 regenerates the molding data such that the molding time of the molding data scheduled at the time immediately before the non-operation time period elongates into the range of the non-operation time period. In contrast, the data generation unit 411 may regenerate the molding data such that the molding time of the molding data scheduled at the time immediately after the non-operation time period elongates into the range of the non-operation time period.

### D. Fourth Embodiment

The configuration of the three-dimensional molding system 10 in a fourth embodiment is the same as that in the first embodiment. In the fourth embodiment, the molding data registered in the molding schedule information is regenerated according to molding priority.

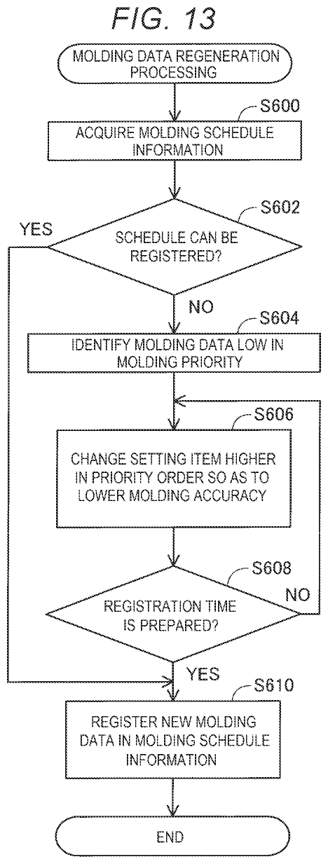

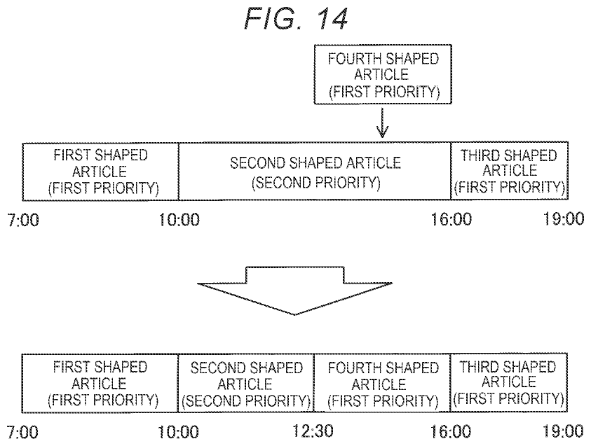

FIG. 13 is a flowchart of molding data regeneration processing executed by the data generation unit 411 of the information processing device 400 in the fourth embodiment. FIG. 14 is an illustration diagram of the molding data regeneration processing according to the fourth embodiment. The molding data regeneration processing in the fourth embodiment is performed when new molding data is going to be registered in the molding schedule information.

As illustrated in an upper part of FIG. 14, in the fourth embodiment, the molding data registered in the molding schedule information and the molding data to be registered schedule information are molding respectively assigned with molding priorities. In the present embodiment, a first molding priority or a second molding priority having a lower priority than the first molding priority is assigned as the molding priority. In the upper part of FIG. 14, the molding data of the first shaped article, the second shaped article, and the third shaped article are registered in the molding schedule information. The first molding priority is assigned to the first shaped article and the third shaped article, and the second molding priority is assigned to the second shaped article. The first molding priority is assigned to the fourth shaped article to be registered in the molding schedule information. In the molding data assigned with the first molding priority, the molding quality is prioritized over the molding data assigned with the second molding priority.

In step S600 in FIG. 13, the data generation unit 411 of the information processing device 400 acquires the molding schedule information from the three-dimensional molding apparatus 100.

In step S602, the data generation unit 411 determines whether new molding data to be registered in the molding schedule information can be registered in the molding schedule information acquired in step S600. For example, the upper part of FIG. 14 illustrates a state in which the molding data of the fourth shaped article is going to be registered in the molding schedule information. When the data generation unit 411 determines that the non-operation time period equal to or longer than the molding time of the molding data to be registered in the molding schedule information is present in the molding schedule information, the data generation unit 411 determines that new molding data can be registered in the molding schedule information.

In step S602, when it is determined that new molding data can be registered in the molding schedule information, the data generation unit 411 proceeds with the process to step S610 to register the new molding data to the non-operation time period in the molding schedule information.

When it is determined in step S602 that new molding data cannot be registered in the molding schedule information, the data generation unit 411 identifies the molding data having a lower molding priority than the molding priority of the molding data to newly be registered in the molding schedule information in step S604 from the molding data registered in the molding schedule information. In the example illustrated in FIG. 14, the molding priority of the molding data of the second shaped article is lower than the molding priority of the molding data of the fourth shaped article to newly be registered. When the molding data with low molding priority cannot be identified, the data generation unit 411 displays an error on the display unit 480 and ends the molding data regeneration processing.

In step S606, the data generation unit 411 acquires the molding data with the low molding priority identified in step S604 from the three-dimensional molding apparatus 100, and then regenerates the molding data such that the molding accuracy of the molding data is lowered. Specifically, the setting value of the setting item having the high priority order shown in FIG. 9 is changed so that the molding accuracy is lowered. Then, the molding data is generated again using the setting value thus changed, and the molding time during which the molding is performed with that molding data is calculated.

In step S608, the data generation unit 411 determines whether time for registering the molding data to be newly registered is prepared. When the difference between the predicted molding time calculated in step S606 and the initial molding time before the setting value is changed becomes equal to or longer than the molding time of the shaped article to newly be registered, the data generation unit 411 determines that the time is prepared. When the molding time and the non-operation time period of the molding data having the low molding priority are continuous, the data generation unit 411 determines that the time is prepared when the time obtained by adding the non-operation time period to the difference between the predicted molding time calculated in step S606 and the initial molding time is equal to or longer than the molding time of the shaped article to newly be registered.

When the data generation unit 411 determines in step S608 that the time for registering the molding data is not prepared, the data generation unit 411 returns the process to step S606 to change the setting value so as to reduce the molding accuracy, and then generates the molding data. Similarly to the first embodiment, the data generation unit 411 determines the setting item to be changed according to the priority order illustrated in FIG. 7.

When the data generation unit 411 determines in step S608 that the time for registering the molding data is prepared, the data generation unit 411 registers the new molding data in the time thus prepared in the molding schedule information. In this way, as illustrated in a lower part of FIG. 14, the molding time of the shaped article having the low molding priority is shortened, and the molding data of the new shaped article having the high molding priority is registered in the molding schedule information.

According to the fourth embodiment described above, when the molding schedule of the three-dimensional shaped article having the first molding priority overlaps the molding schedule of the three-dimensional shaped article having the second molding priority lower than the first molding priority, the molding data is regenerated so that the molding time of the three-dimensional shaped article having the second molding priority is shortened. Therefore, it is possible to register new molding data in the molding schedule while adjusting the molding quality of the three-dimensional shaped article according to the molding priority.

### E. Fifth Embodiment

A fifth embodiment is different from the fourth embodiment in that not only the molding priority but also user information is associated with the molding data, and is the same as the fourth embodiment in other points. The user information means information representing the owner of the molding data.

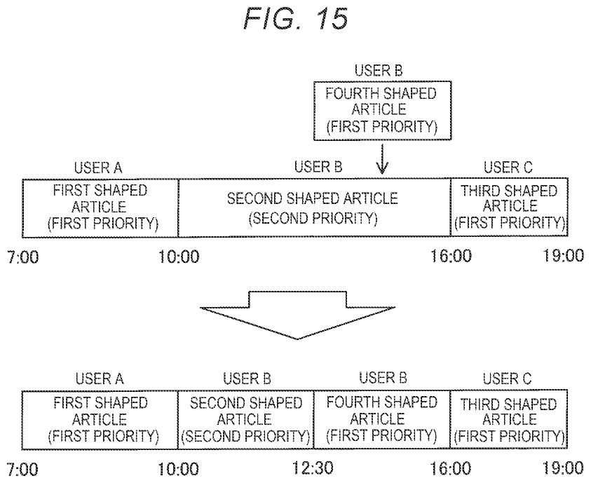

FIG. 15 is a diagram showing an example of shaping schedule information according to the fifth embodiment. As illustrated in an upper part of FIG. 15, the user information is associated with each piece of molding data. In the fifth embodiment, in step S604 of FIG. 13, the data generation unit 411 identifies molding data having a lower molding priority than the molding data to newly be registered and having user information common to the molding data to newly be registered. In this way, when the molding schedule of the three-dimensional shaped article having the first molding priority overlaps the molding schedule of the three-dimensional shaped article having the second molding priority, the molding data is regenerated so that the molding time of the three-dimensional shaped article having the second molding priority is shortened only when the user information of the three-dimensional shaped article having the first molding priority is common to the user information of the three-dimensional shaped article having the second molding priority. As a result, as illustrated in a lower part of FIG. 15, the molding time is adjusted between the molding data associated with the same user information. Therefore, it is possible to prevent the molding time of the molding data of another person from being changed.

The administrator authority may be given to the user information. In this case, when the user information of the molding data to newly be registered is the user information having the administrator authority, the molding time of any of the molding data can be adjusted regardless of the user information. For example, in the upper part of FIG. 15, when a user B of the fourth shaped article has the administrator authority, it is possible to shorten the molding time of the first shaped article of a user A and the third shaped article of a user C to prepare the molding schedule of the fourth shaped article in addition to the second shaped article having the common user information.

### F. Sixth Embodiment

In a sixth embodiment, the configuration of the three-dimensional molding system 10 is the same as that of the first embodiment. The sixth embodiment is different from the first embodiment in the steps of the method of manufacturing the three-dimensional shaped article shown in FIG. 8.

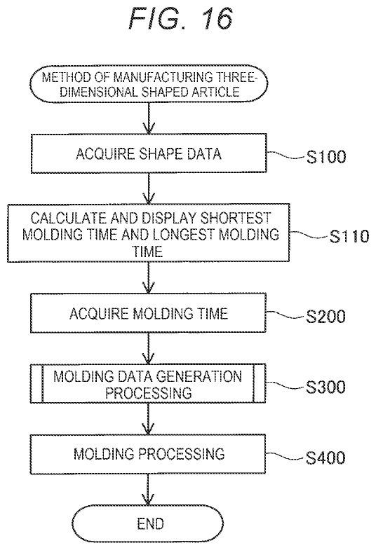

FIG. 16 is a process diagram showing the steps of the method of manufacturing the three-dimensional shaped article according to the sixth embodiment. In the sixth embodiment, processing in step S110 is added to the process diagram shown in FIG. 8. In step S110, the data generation unit 411 of the information processing device 400 generates the molding data in which the molding accuracy is reduced to the lowest to shorten the molding time, and generates molding data in which the molding accuracy is increased to the highest to lengthen the molding time by changing the setting values illustrated in FIG. 7. Then, the data generation unit 411 calculates the molding time of the three-dimensional shaped article based on the molding data, and displays the molding time as the shortest molding time and the longest molding time on the display unit 480 to notify the user. At this time, it is preferable to generate and display a preview image of each of the three-dimensional shaped article to be formed in the shortest molding time and the three-dimensional shaped article formed in the longest molding time.

According to the sixth embodiment described above, the user can designate the molding t time while checking the shortest molding time and the longest molding time displayed on the display unit 480. When the preview image of the shaped article shaped in the shortest molding time and the preview image of the shaped article shaped in the longest molding time are respectively displayed, the molding time can be designated while confirming both the molding time and the molding quality. The shortest molding time and the longest molding time may be announced to the user with voice.

### G. Other Embodiments

(G1) In the first embodiment, the data generation unit 411 may display an error on the display unit 480 when the molding time designated by the user cannot be realized even when each setting value is changed to the maximum value or the minimum value. In this case, the data generation unit 411 may request the user to designate the molding time again. The data generation unit 411 may receive, from the user, an instruction to generate the molding data based on the setting values with which the molding time closest to the designated molding time can be realized.

(G2) In each of the above embodiments, the data generation unit 411 may receive an instruction to fix the setting values from the user, for example, to fix the line width and the ejection height to 0.5 mm, respectively. When the user instructs to fix the setting values, the data generation unit 411 generates the molding data by changing the setting value other than the setting value thus fixed. In this way, the convenience for the user can be improved.

(G3) In the second to fifth embodiments, the molding schedule information shown in FIG. 9 and the like is stored in the storage device 320 of the three-dimensional molding apparatus 100. In contrast, the molding schedule information may be stored in the storage device 430 of the information processing device 400.

(G4) In the above-described embodiments, the molding time designated by the user is not limited to a fixed time such as 1 hour or 2 hours, and may be a time having a range such as 2 hours or more, 2 hours or less, or 1 to 2 hours.

(G5) In the above embodiments, the plasticizing unit 30 plasticizes the material with the flat screw. In contrast, the plasticizing unit 30 may plasticize the material by rotating an in-line screw, for example. As the molding unit 110, a head used in a fused deposition modeling may be adopted.

### H. Other Aspects

The present disclosure is not limited to the embodiments explained above and can be implemented in various configurations without departing from the gist of the present disclosure. For example, technical features in the embodiments corresponding to technical features in aspects explained below can be replaced or combined as appropriate in order to solve a part or all of the problems described above or in order to achieve a part or all of the effects described above. Unless the technical features are explained as essential technical features in the present specification, the technical features can be deleted as appropriate.

(1) According to a first aspect of the present disclosure, there is provided a method of manufacturing a three-dimensional shaped article by ejecting a plasticized material from an ejection unit toward a stage to stack layers. The method for manufacturing a three-dimensional shaped article includes: (a) acquiring first data representing a shape of the three-dimensional shaped article; (b) acquiring time designation information designating a molding time in which molding of the three-dimensional shaped article is completed; (c) generating, based on the first data and the time designation information, second data including information of a path of the ejection unit to the stage, and information of an ejection amount of the plasticized material in the path so that molding of the three-dimensional shaped article is completed within the molding time designated; and (d) controlling the ejection unit based on the second data to mold the three-dimensional shaped article.

According to such an aspect, the molding data is generated such that the three-dimensional shaped article is molded within the molding time designated. Therefore, the molding of the three-dimensional shaped article can be completed within the molding time designated.

(2) In the aspect described above, in the step (c), the second data may be generated such that molding of the three-dimensional shaped article is completed within the molding time designated by changing a setting value of at least one setting item among a setting related to a path, a setting related to an ejection amount, a setting related to moving speed of the ejection unit, and a setting related to maintenance of the ejection unit from an initial value.

(3) In the aspects described above, a priority order may be determined in advance for the setting items, and in the step (c), a setting value of the setting item high in priority order may be changed with priority. With this configuration, for example, it is possible to shorten the molding time while giving priority to the molding quality.

(4) In the aspects described above, in the step (c), predicted molding time calculated using the setting value and the molding time designated may be compared to each other to determine whether the molding is completed within the molding time designated, and the second data may be generated by changing the setting value of the setting item high in priority order with priority when the molding is not completed within the molding time designated, and repeating the change of the setting value until the predicted molding time calculated based on the setting value changed falls within the molding time designated. With this configuration, the molding time of the three-dimensional shaped article can be brought close to the molding time designated.

(5) The aspects described above may further include acquiring molding schedule information of the three-dimensional shaped article, wherein in the step (b), a non-operation time period during which the three-dimensional molding apparatus is not in operation may be identified from the molding schedule information, and a time period within the non-operation time period identified may be acquired as the time designation information. According to such an aspect, it is possible to mold a three-dimensional shaped article by effectively utilizing the non-operation time period of the three-dimensional molding apparatus.

(6) The aspects described above may further include: acquiring molding schedule information of the three-dimensional shaped article; and identifying, from the molding schedule information, a non-operation time period during which the three-dimensional molding apparatus is not in operation to regenerate second data of the three-dimensional shaped article scheduled at time immediately before or immediately after the non-operation time so that the molding time of the second data elongates into a range of the non-operation time period. According to this aspect, since the molding time of the three-dimensional shaped article can be extended into the non-operation time period of the three-dimensional molding apparatus, the three-dimensional shaped article can be shaped with high quality.

(7) The aspects described above may further include: acquiring molding schedule information of the three-dimensional shaped article; and regenerating the second data such that when molding schedule of the three-dimensional shaped article having a first molding priority overlaps molding schedule of the three-dimensional shaped article having a second molding priority lower than the first molding priority, the molding time of the three-dimensional shaped article having the second molding priority is shortened. According to such an embodiment, the molding quality of the three-dimensional shaped article can be adjusted according to the molding priority.

(8) The aspects described above may further include: acquiring molding schedule information of the three-dimensional shaped article and user information of the three-dimensional shaped article; and regenerating the second data such that when molding schedule of the three-dimensional shaped article having a first molding priority overlaps molding schedule of the three-dimensional shaped article having a second molding priority lower than the first molding priority, and when the user information of the three-dimensional shaped article having the first molding priority is common to the user information of the three-dimensional shaped article having the second molding priority, the molding time of the three-dimensional shaped article having the second molding priority is shortened. According to such an aspect, it is possible to prevent the molding time of the molding data of another person from being changed.

(9) The aspects described above may further include: calculating a shortest molding time and a longest molding time of the three-dimensional shaped article and notifying a user of the shortest molding time and the longest molding time. According to such an aspect, the user can designate the molding time while checking the shortest molding time and the longest molding time.

The present disclosure is not limited to the method of manufacturing a three-dimensional shaped article described above, and can be implemented with various aspects such as a three-dimensional molding system, a three-dimensional molding apparatus, a computer program, and a non-transitory tangible computer-readable storage medium storing the computer program.

What is claimed is:

1. A method of manufacturing a three-dimensional shaped article by ejecting a plasticized material from an ejection unit toward a stage to stack layers, the method comprising:
(a) acquiring first data representing a shape of the three-dimensional shaped article;
(b) acquiring time designation information designating a molding time in which molding of the three-dimensional shaped article is completed;
(c) generating second data including information of a path of the ejection unit to the stage and information of an ejection amount of the plasticized material in the path so that molding of the three-dimensional shaped article is completed within the molding time designated based on the first data and the time designation information; and
(d) controlling the ejection unit based on the second data to mold the three-dimensional shaped article.

2. The method of manufacturing the three-dimensional shaped article according to claim 1, wherein
in the step (c), the second data is generated so that molding of the three-dimensional shaped article is completed within the molding time designated by changing a setting value of at least one setting item among a setting related to a path, a setting related to an ejection amount, a setting related to moving speed of the ejection unit, and a setting related to maintenance of the ejection unit from an initial value.

3. The method of manufacturing the three-dimensional shaped article according to claim 2, wherein
a priority order is determined in advance for the setting items, and
in the step (c), a setting value of the setting item high in priority order is changed with priority.

4. The method of manufacturing the three-dimensional shaped article according to claim 3, wherein,
in the step (c),
predicted molding time calculated using the setting value and the molding time designated are compared to each other to determine whether the molding is completed within the molding time designated, and
the second data is generated by changing the setting value of the setting item high in priority order with priority when the molding is not completed within the molding time designated, and repeating the change of the setting value until the predicted molding time calculated based on the setting value changed falls within the molding time designated.

5. The method of manufacturing the three-dimensional shaped article according to claim 1, further comprising:
acquiring molding schedule information of the three-dimensional shaped article, wherein
in the step (b), a non-operation time period during which the three-dimensional molding apparatus is not in operation is identified from the molding schedule information, and a time period within the non-operation time period identified is acquired as the time designation information.

6. The method of manufacturing the three-dimensional shaped article according to claim 1, further comprising:
acquiring molding schedule information of the three-dimensional shaped article; and
identifying, from the molding schedule information, a non-operation time during which period the three-dimensional molding apparatus is not in operation to regenerate second data of the three-dimensional shaped article scheduled at time immediately before or immediately after the non-operation time so that the molding time of the second data elongates into a range of the non-operation time period.

7. The method of manufacturing the three-dimensional shaped article according to claim 1, further comprising:
acquiring molding schedule information of the three-dimensional shaped article; and
regenerating the second data so that when molding schedule of the three-dimensional shaped article having a first molding priority overlaps molding schedule of the three-dimensional shaped article having a second molding priority lower than the first molding priority, the molding time of the three-dimensional shaped article having the second molding priority is shortened.

8. The method of manufacturing the three-dimensional shaped article according to claim 1, further comprising:
acquiring molding schedule information of the three-dimensional shaped article and user information of the three-dimensional shaped article; and
regenerating the second data so that when molding schedule of the three-dimensional shaped article having a first molding priority overlaps molding schedule of the three-dimensional shaped article having a second molding priority lower than the first molding priority, and when the user information of the three-dimensional shaped article having the first molding priority is common to the user information of the three-dimensional shaped article having the second molding priority, the molding time of the three-dimensional shaped article having the second molding priority is shortened.

9. The method of manufacturing the three-dimensional shaped article according to claim 1, further comprising:
calculating a shortest molding time and a longest molding time of the three-dimensional shaped article and notifying a user of the shortest molding time and the longest molding time.
